(19) United States
(12) Patent Application Publication
(10) Pub. No.: US 2010/0198606 A1
(43) Pub. Date: Aug. 5, 2010

(54) Remote control system and method of the infringement to the traffic regulations

(76) Inventors: Andrea Gherardi, Casciana Terme (IT); Fabio Salvadori, Casciana Terme (IT)

Correspondence Address: Themis Law, 7660 Fay Ave Ste H-535, La Jolla, CA, 92037, US

(21) Appl. No.: 12/671,500

(22) PCT Filed: Aug. 3, 2007
(86) PCT No.: PCT/IT07/00564

§ 371 Date: Jan. 29, 2010

(51) Int. Cl. G08G 1/052; G06F 17/30; G01S 19/42; G06Q 50/00

(52) U.S. Cl. 705/1.1; 707/769; 707/802; 701/117; 342/357.25; 701/33; 707/E17.044; 707/E17.014

(57) ABSTRACT

A control system for monitoring violations to circulation rules includes a detector and recording device of the position of a vehicle, installed on the same vehicle, and electronic equipment that compares data detected and recorded by the device with data contained in a centralized data base, which contains information relative to traffic rules, allowing in this manner the imposition of fines.

### TECHNICAL FIELD

The invention relates to systems and methods of verifying compliance with speed limits, and in general with regulating traffic in specified areas or road sections.

### BACKGROUND ART

Nowadays the compliance with traffic rules and other traffic regulations is guaranteed by the control made by authorities such as police, or traffic officers that perform these duties by sending their officers directly to the place that must be supervised or patrolled.

This system, even if it involves a reasonable number of people, does not permit a total and on-going control of all the areas and roads for which it is been necessary and for this reason systems have been devised which assist the operator responsible for traffic control, in a way to supervise all the road sections more frequently. These systems are by now limited to controlling the compliance with speed limits in particularly critical zones. It is about accurate controls in limited road sections and not extended to all types of infringements.

Till now indeed systems have been used such as Autovelox and tutor for speed control in fixed positions or even Autovelox in mobile positions and Telelaser, which requires anyway the presence of an operator.

These systems show limits in terms of costs, applicability, difficulty, and moreover need the installation of expensive devices both for the assemblage and maintenance and the recourse to a large number of employees who provide for the detection of the infringement or the up dating of the fixed devices.

Moreover these devices are usually static, in a sense that they either provide the trespassing of a speed limit or verify if a driver has violated a different regulation, for example by entering a one way road from the other way or by entering a restricted traffic zone.

To verify the existence of these infringements video-cameras may be installed that shoot photos or frame the cars passing in zones where they are not allowed, but also this installation is expensive and requires still a lot of work from the operators who must look at the photos or the videos and only after that apply the appropriate fine.

An unexpected difficulty of the violation detection systems is that they are constituted by different means depending on the violation type that has been made. To detect the infringement of a speed limit exceeding there are different devices from the ones that are used to verify the passing of a red light, for example.

Another inconvenient is that today's devices are not easily updateable and moreover the Autovelox is not very accurate. If in a street there is a light that for a certain amount of time is set on flashing position because of some work in progress, it will be necessary to intervene to deactivate the eventual video-camera placed to control traffic or leave it to work without then the possibility to apply fines with high and unnecessary waste of time and money.

In addition the known devices have a remarkable environmental impact, as they are well-visible devices that change the conditions of the places where they are installed. Additionally recourse to video frames and photos to verify the occurrence of violations seriously violates the citizens' privacy that results to be compromised.

These are just some of the many disadvantages offered by the I-known devices.

### DISCLOSURE OF INVENTION

The goal of the present invention is to resolve the aforesaid and other drawbacks in the prior art.

In one embodiment, a system according to the invention provides surveillance on speed limits, but also of other types, restrictions or obligations, in determinate zones, without the necessity of a ongoing presence of the supervising staff. A system according to the invention also allows a monitoring of violations also at a distance or in a second instance.

The invention includes the usage by the vehicles of a route recorder GPS device with a non-volatile memory. The device records in prefixed time-slot, or in a time-slot variable depending on speed, the data relative to hour, minutes and position, with an accuracy that depends on the satellite locating system, which may be a standard GPS, the Galileo system or another locating system.

By means of appropriate software, it is possible to recreate from these data all the vehicle's routes, the stopover made and the speeds kept during the entire period of the recording.

At the same time, the system comprises the usage by a public administrator of a mapping database containing information relative to the traffic rules of the vehicles in the sensitive areas of the territory, or better the speed limits on streets and highways, prohibition on transit, to access or to stop or other conditions relative to specified zones.

The authorities in charge to control can acquire the recorded data on board of the vehicle and, by means of appropriate software, compare the vehicle's behaviour with the information in the database, obtaining the eventual violation that has been made.

The system is almost applicable to the control of all the traffic rules, from permanent speed limits to the temporary limits on a daily or weekly or monthly basis, to the control of one-way routes, prohibition on transit and stop, traffic blocks to special vehicles etc.

The system comprises also a sign-signal to indicate when this type of control is used, in a way to get a correct behaviour of the drivers. In this way the system permits for example to obtain the same result as speed control devices, without the costs and complications that these involve.

In case of an accident the system provides the route recordings of the involved vehicles, such to rebuild with a good approximation and in an objective manner the accident's dynamic.

The method is summarized in the flow-chart shown in FIG. 1.

An exemplary implementation of a system according to the invention is described hereinafter.

With reference to FIG. 2, a GPS receiver device (2) is installed on board of a transportation vehicle (1) that allows recording data relative to hours, minutes, and seconds and position (latitude and longitude) obtained from a satellite signals (3) and a vehicle movement or stopping indication signal. The data are recorded in prefixed time-slot, or in a time-slot that varies depending on speed, with a time lapse of a few seconds, and are not changeable. The data storage can contain data relative to a period of time of one year or equivalent, after which the older data are replaced with newer ones. The device is subject to an official approval and has an unambiguous serial number associated to the vehicle on which it is installed and therefore to its owner. This serial number is carried forward on the vehicle logbook and is comprised in data recorded in the device storage.

The installed device is not removable or cannot be disabled, if not by a trained operator, and has a connector placed on the external part of the vehicle compartment for the reading and acquisition of the storage data.

The public authorities, directly or through an external administrator, retain an updated database (4) in which there is found, together with the mapping information, all the information relative to permanent or temporary speed limits, bans, obligations and conditions, that concern different street or area routes.

That includes for all those areas or street routes of the territory under control where, for particular features as danger, school presence, build-up area or restricted traffic zones, traffic intensity etc., for which an ongoing control of road traffic is desired.

The public authorities, through operators (5), acquire, during ordinary service control or during particular events such as accidents or road blocks, the data recorded on the storage of the vehicle device subject to control and eventually proceeds in deleting or marking the data that has already been acquired (6).

Locally, with an installed software on a Notebook which is connectable to the updated data base, or at another time from the command centre by means of appropriate processors (7), therefore on site or at a central location, the acquired data are processed to obtain the paths driven by the vehicle, comprising information on the maintained speed during the entire period to which the data relates.

These paths are therefore compared to the ones present in the database and compliance is verified or the disregard to the imposed traffic rules.

The acquired data can include also the information on the headlamps' conditions or on other vehicle devices.

The data logger installed on board of the vehicle can allow the recording, along with the above mentioned data (position, time, etc.), of a number of other data that indicate the functioning and management status of the vehicle and the physical condition of the driver. Examples of these types of data are those relative to: light activation, right and left signals activation, brake activation, the use of seatbelts, distance from the preceding vehicle, data obtained through biometric sensors which give the data relative to the condition of the driver (blood alcohol concentration, etc.).

The gathering in the data logger of these data can happen ether through an appropriately programmed controller, and therefore the data become directly interfaced with the data logger, or through the installation on board of the vehicle of appropriate signal transducers for the connection of the data to the data logger.

Also the aforesaid data are added to the data relative to the vehicle's position to verify if, depending on the position and on the time at which it was in that position, the driver had activated the required devices on the vehicle.

All the cases, in which this crossed control gives a negative result, are recorded in detail in a report, upon which there are issued fines or actions taken toward the vehicle's owner (8).

Referring now to FIG. 3, in the street routes and areas where this type of ongoing control is active, a related, specific sign (9) (10) is used alone or with the ordinary road signs (11 to highlight that, for example, a rectangular sign with a two colour double horizontal band (9) indicates the start of the ongoing control. A similar sign with the white double band and the black oblique strip (10) indicates instead the end of the active ongoing control area.

The drivers are warned this way that even in the absence of agents carrying out the control, the behaviour of their vehicle on that route can be controlled at any time.

The recording device has shock absorption, fire-resistant or immersion in water proof features, in a way to be used also to rebuild with accuracy the accident dynamics, even when the vehicle becomes very damaged.

In an improved version of the system, the recording device records also the data relative to the vehicle's parameters as turning on or not the lights, fasten the seat belt, brake conditions, loading relevance etc., or obtains data relative to the driver and to his/her driving documents, and the system may also control their conditions.

According to a different embodiment, a system according to the invention may include, in some particularly critical routes, some sensors which obtain the presence of fog, rain or ice, by means of which the mapping data base is included, in a way to modify dynamically the controlling parameters comprised in it according to rules imposed and dependent on different factors, as in the case of speed limits that are more restrictive in the presence of rain.

By allowing the owners of the vehicles to access to the acquired data and to the database, they have also the opportunity to control by themselves the behavior and the eventual violations committed by the drivers, for example the system permits a control of the behaviour of the new-drivers by the parents, or of the employees by a company or of clients by an insurance company in order to apply correctly rates and discounts or it can be used by the drivers to control in an independent manner their own driving, and with the perspective to receive reduced fines, to report their own violations.

The updating of the system according to changes in traffic or for temporary situations, becomes very simple because it regards only the database and not the devices on board of the vehicles, which are restricted to recording the position.

A simple updating procedure comprises that, contextually to the adjustment of road signs, the route or area authority proceeds, directly or though a third party administrator of the data base, to insert the data relative to the changes, and after communicating the new version of the software to all the administrators or control parties so that they can obtain updated versions. The referential database can also be subdivided in more sections or modules, corresponding to the different parts of the territory (highway or urban area or municipal road) that are the responsibility of different administrators. Depending on the path of the vehicle, the different appropriate sections of the database may be used for the verification of the data.

For the purpose of the present description, the term “vehicle” and “vehicles” relate to any transportation unit in movement that must follow traffic rules, including therefore not only land motor vehicles but also to the nautical ones, airplanes or vehicles of other types.

Referring to the figures of the drawings enclosed herein, a violation control system according to the present invention comprises:
at least a detector and recording device of the position of a vehicle;
at least a centralized database comprising information relative to the traffic regulations
   which, comparing by means of electronic equipment data related to the circulation of a vehicle with the data in the data base, can record whether any violation has occurred.

The device that detects and records such data is a single device but the same result is obtained, as equivalent, when using two different devices, of which the first one detects and the second one records the data.

The detector and recording device of the position of a vehicle is a GPS receiver with non-volatile storage, able to record constantly or in a prefixed time-slot, or in a time-slot that is variable depending on speed, data relative to the time and position of the vehicle such as latitude and longitude, optionally a running or stopping position of the vehicle, optionally data relative to the functional parameters of the vehicle such as the activation of lights, directional signals, commands and signals coming from the sensors assembled on board of the vehicle and optionally data relative to the driver of the vehicle or to the holder of the device.

The data logger installed on board of the vehicle can allow the recording, along with the above described data (position, time, etc.), of a number of other data that indicate the functioning and management status of the vehicle, and the physical condition of the driver. Examples of these types of data are those relative to: light activation, right and left signals activation, brake activation, the use of seatbelts, distance from the preceding vehicle, data obtained through biometric sensors which provide data relative to the condition of the driver (blood alcohol concentration, etc.).

The gathering in the data logger of these data can happen ether through an appropriately programmed controller, and therefore directly interfaced with the data logger, or through the installation on board of the vehicle of appropriate signal transducers for the connection of the data to the data logger.

Moreover, the aforesaid data are added to the data referring to the vehicle's position to verify if, depending on the position and on the time in which it was in that position, the driver had activated the required devices on the vehicle.

A centralized database is an electronic file available to the control board or to authorized personnel, containing mapping information together with information relative to the traffic regulations for the vehicle such as compulasory activities, prohibited activities, and rules existing in an area or route on which the control system is active, and optionally containing information coming from sensors, climatic and not, installed in the area.

A remote access may be made to this centralized database, using electronic equipment made available in case of need.

As an alternative, this centralized database is downloaded on electronic equipment able to compare the data. Updates to the database will also be downloaded on this type of equipment from time to time.

Electronic equipment able to compare the data of the data base with the data of the vehicle comprises one or more electronic processors connectable to each other, one or more ports or link interfaces of a processor to a recording device of a vehicle to allow the acquisition of the recorded data in the device by the processor, and one or more system software programs at least able to:
process the data and obtain the shift vectors and the vehicle speed in the course of time,
compare those vectors and data with the reference map comprised in the data base, and
highlight a possible violation committed by the vehicle.

In on embodiment, the above system comprises different signals (9) (10) (11) to identify the areas or the single rule for the regulation of the traffic over which the control system is active. In detail, the signal includes a rectangular signpost with a two colour horizontal double band (9) to be used alone to identify the areas over which the control system is active or together with other signposts (11) to identify single rules for which the control system is active, and a similar signpost with a double white band and a oblique black strip (10) indicates the end of the ongoing control.

Advantageously, a detector and recording device of the position of a vehicle is installed on the vehicle in a fixed manner, is not removable or cannot be disabled, if not by a trained operator, with the port or interface for the download of the data accessible with appropriate means also from the outside of the vehicle, and is singularly identified in relation to the vehicle on which it is installed, and the data that it records are unequivocally related to it.

The storage portion of the aforesaid detector and recording device is neither erasable nor modifiable if not by personnel having specified access codes, in particular by authorities in charge of control, and contains at least a quantity of useful data for the reconstruction of the routes followed by the vehicle in the last period of time of a minimum pre-established time interval in order to perform control.

The detector and recording device of the position is high/low temperature, and/or impact and/or water and ice resistant.

Advantageously the data acquired by the detector and recording device are readable by other authorities or by other personnel that have an interest and are authorized by means of specified access codes. Moreover, authorities or private citizens can access and read the data base or part of it, and can read the data acquired by the detector and recording device assembled on a vehicle, for which they have authorization and control, independently from the behavior of the vehicle, in order to verify the route, control the correctness of the driving or reconstruct an event, but may not delete the data.

The above data base is unique or assembled in a plurality of sections or different modules, to which the control software is connected and one or more administrators are in charge of updating the data base or one or more modules or sections of it when asked by the administrators that are in charge of regulating the traffic, and to update all the authorities responsible for the control.

The system can also comprise the automatic dispute of estimated fines for the covered violations.

The system allows a verification of any kind of violation, including passing through a red light, non stopping at a stop, driving on a one-way road in the wrong direction, or other actions, being not limited to control driving over the speed limits.

The system can comprise a device installed on board of a vehicle that works as an interface with the detector system of the position, such to function as a satellite navigator. Optionally this device can visualize the data relative to traffic signs and/or speed limits of the street where the vehicle is driving.

By using a device according to the invention to plan a route, it will be possible to acquire data updated with the signals and limits relative to that route, and be informed about it while driving.

### BRIEF DESCRIPTION OF DRAWINGS

FIG. 1 shows a flow-chart of a method of violation detection according to the invention.

FIG. 2 shows a diagram of a system according to the invention

FIG. 3 shows an example of traffic signs for the detector system.

FIG. 4 shows the signs of FIG. 3 used in addition to other road signs.

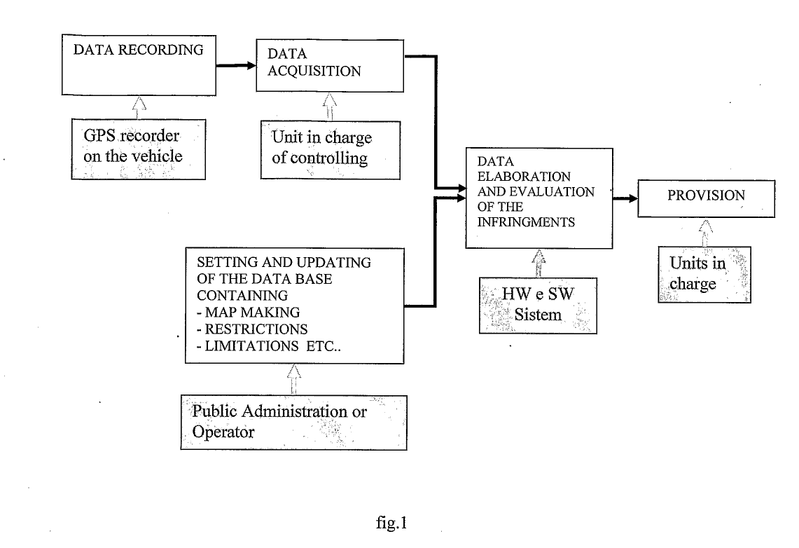

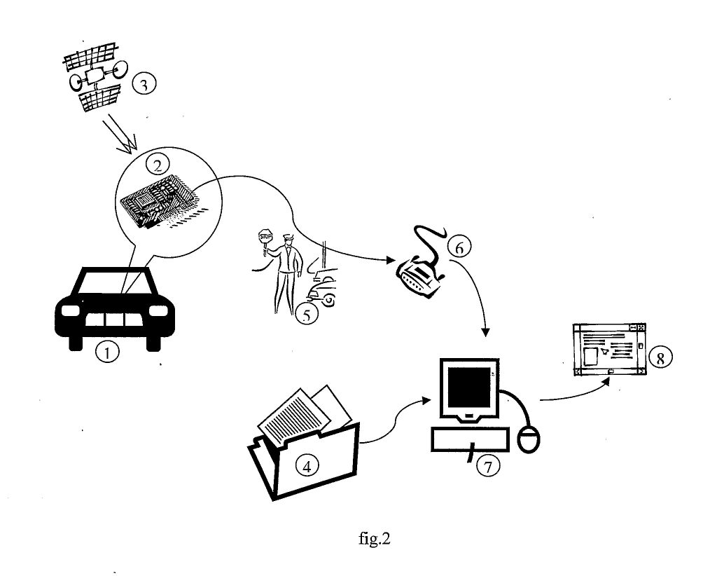

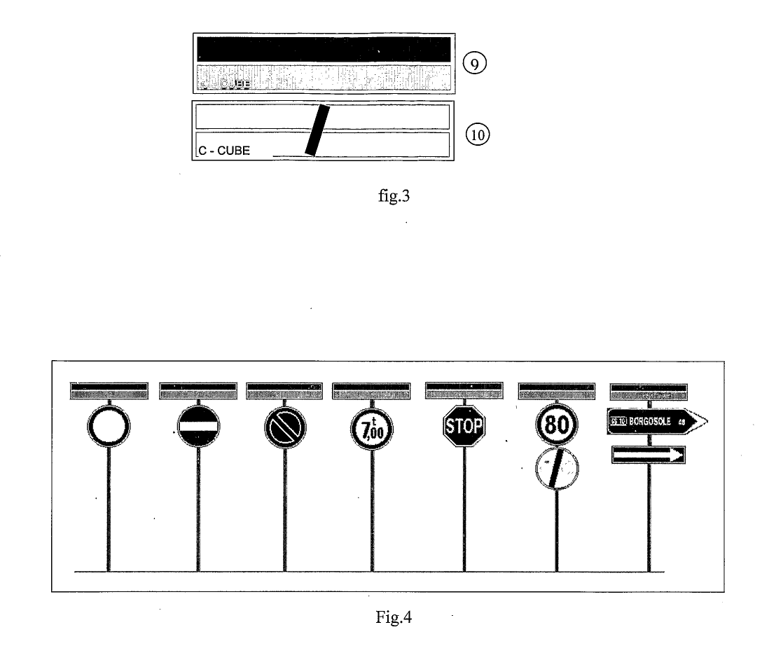

What is claimed is:

1.-29. (canceled)

30. A control system to monitor violations of traffic rules comprising:
a detector and recording device comprising a data logger installed on a vehicle and configured to record one or more of a position of the vehicle or information on the vehicle, the detector and recording device being further configured to record continually or at a predetermined time;
a memory configured to store a centralized database comprising information on one or more of regulation of road traffic or map information; and
computer equipment configured to run software, the computer equipment being connectable to the database, the software processing acquired data to obtain a path driven by the vehicle that comprises data on vehicle travel, the path being comparable to data in the database such to detect a violation of the traffic rules,
wherein the computer equipment comprises a portable notebook for locally acquiring data about the vehicle from the data logger such to enable processing of the acquired data.

31. The control system of claim 30, wherein the notebook is remotely connectable with the centralized data base such to process the acquired data.

32. The control system of claim 30, further comprising a processor directly connecting the notebook with the data of the centralized data base.

33. The control system of claim 30, wherein the data logger comprises a non volatile memory.

34. The control system of claim 30, wherein the detector and recording device is a GPS receiver.

35. The control system of claim 30, wherein said detector and recording device is configured to record at least data relative to time and geographic position of the vehicle.

36. The control system of claim 30, wherein the detector and recording device is configured to record one or more of running or stopping signals from the vehicle, data relative to functional parameters of the vehicle, activation of lights, directional signals, command signals, signals coming from sensors assembled on board of the vehicle, data relative to a driver of the vehicle or to a holder of the detector and recording device.

37. The control system of claim 30, wherein the data logger further records data related to one or more of operational status of the vehicle, physical condition of a driver, light activation, right and left signal activation, brake activation, use of seatbelts, distance from a preceding vehicle, or data from biometric sensors which provide data relative to the physical condition of the driver or blood alcohol concentration.

38. The control system of claim 37, wherein the recorded data are crossed-checked with the acquired data referring to the vehicle's position to verify if, depending on the position and on a time at that position, the driver had activated required devices on the vehicle.

39. The control system of claim 30, wherein the data is acquired through a controller directly interfaced with the data logger, or through installation on board of the vehicle of appropriate signal transducers transmitting the data to the data logger.

40. The control system of claim 30, wherein the centralized database is an electronic file available to a control board and containing mapping information together with information relative to the traffic rules for the vehicle comprising one or more of obligations, prohibitions, rules in force in an area or route where the control system is active, or information provided by locally installed sensors.

41. The control system of claim 30, wherein the centralized database is downloaded on the computer equipment to compare the data, and wherein the database is also downloaded on the computer equipment from time to time.

42. The control system of claim 30, wherein the computer equipment is configured to compare the data of the database with the data of the vehicle and comprises:
one or more electronic processors connectable to each other;
one or more ports or link interfaces of a processor to a recording device of a vehicle to allow the acquisition of the recorded data in the device by the processor; and
a memory storing the software.

43. The control system of claim 30, wherein the computer equipment is programmed to perform the steps of:
processing the data to obtain shift vectors and vehicle speed in the course of time; and
comparing the shift vectors and the data with a reference map comprised in the database.

44. The control system of claim 30, further comprising one or more street signs identifying an area or a single rule for regulating the traffic, over which the control system is active.

45. The control system of claim 44, wherein the one or more street signs comprise a rectangular signpost having a two color double band identifying a beginning of the area or single rule, and a rectangular signpost having two parallel bands of a same color and a diagonal band therethrough identifying an end of the area or single rule.

46. The control system of claim 30, wherein data stored on the detector and recording device is erasable or modifiable only through specified access codes, and contains at least a quantity of data adequate to reconstruct a route followed by the vehicle in a last predetermined period of time.

47. The control system of claim 30, wherein the data acquired by the detector and recording device are readable only by personnel having a specified access code.

48. The control system of claim 30, wherein the database is arranged in a plurality of different sections or modules readable by the software.

49. The control system of claim 30, wherein the control system is configured to automatically compute an estimated fine for a recorded violation of a traffic rule.
